(19) United States
(12) Patent Application Publication
(10) Pub. No.: US 2011/0007398 A1
(43) Pub. Date: Jan. 13, 2011

(54) DISPLAY FILTER AND PROTECTIVE CASE HAVING GRADATION

(75) Inventors: Jin Sung Lim, ChungCheongNam-Do (KR); Dae Chul Park, ChungCheongNam-Do (KR); Ji Yoon Seo, ChungCheongNam-Do (KR); Kun Yong Jang, ChungCheongNam-Do (KR); Hong Ik Kim, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION GLASS CO., LTD., Gyeongsangbuk-do (KR)

(21) Appl. No.: 12/833,277

(22) Filed: Jul. 9, 2010

(30) Foreign Application Priority Data
Jul. 9, 2009 (KR) 10-2009-0062754

(51) Int. Cl. G02B 5/22

(52) U.S. Cl. 359/614

(57) ABSTRACT

A display filter having a gradation, in use for a display device has a display module therein. The display filter includes a base substrate; and a light blocking section having a light blocking material formed on a periphery area of the base substrate to define an effective image-displaying area of the base substrate. The light blocking material blocks light, and at least a portion of the light blocking section becomes gradually darker in a predetermined direction.

### CROSS REFERENCE TO RELATED APPLICATION

The present application claims priority from Korean Patent Application Number 10-2009-0062754 filed on Jul. 9, 2009, the entire contents of which are incorporated herein for all purposes by this reference.

### BACKGROUND OF THE INVENTION

1. Field of the Invention

The present invention relates to a flat panel display device, and more particularly, to a display filter and a protective case having a gradation.

2. Description of Related Art

In response to the emergence of the advanced information society, components and devices related to photoelectronics have been significantly improved and rapidly distributed. Among them, display devices, which display images, have been widely distributed for use in TVs, Personal Computer (PC) monitors, and the like. Moreover, attempts are underway to simultaneously increase the size and reduce the thickness of such display devices.

In general, a Plasma Display Panel (PDP) device displays an image using gas discharge and has excellent display properties, namely: display capability, luminance, contrast, after-image characteristics, viewing angle, and the like. In addition, the PDP device can easily be made to have a larger size and a thinner profile compared to other display devices.

However, according to its operating characteristics, the PDP device has drawbacks in that it emits a large amount of Electro-Magnetic radiation and Near-Infrared (NIR) radiation and emits neon light of orange color, making color purity worse compared to that of a Cathode Ray Tube (CRT) device. As an attempt to overcome the drawbacks, the PDP device incorporates a display filter including a plurality of optical films, which have a variety of functions such as EMI shielding, NIR blocking, and/or color purity improvement, in order to block the EM radiation and NIR radiation and improve color purity.

In conventional flat display devices, individual providers concentrated their efforts on quality improvement. However, under the current trend of the development and production of such flat display devices, the exterior design is rapidly becoming a key factor that determines the competitiveness of a display device in the market due to the rise in average quality levels. Accordingly, the individual providers are studying the way of improving product designs in order to raise customer awareness on their products and companies and attract customers to purchase their products.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a display filter and a protective case having a gradation, which improve the optical performance and the aesthetic appearance of an exterior design.

In an aspect of the present invention, the display filter having a gradation, in use for a display device having a display module therein, includes a base substrate; and a light blocking section having a light blocking material formed on a periphery area of the base substrate to define an effective image-displaying area of the base substrate. The light blocking material blocks light, and at least a portion of the light blocking section becomes gradually darker in a predetermined direction.

In an exemplary embodiment of the present invention, the display filter may also include a color-adjusting film formed on a predetermined area of the base substrate, such that the color-adjusting film does not cover the effective image-displaying area. The color-adjusting film contains a colorant.

In another aspect of the present invention, the protective case having a gradation includes a light blocking section having a light blocking material formed on a bezel of the protective case to define an effective image-displaying area of the display filter. The light blocking material blocks display light emitted from a display module. At least a portion of the bezel becomes gradually darker in a predetermined direction.

According to exemplary embodiments of the present invention, the display filter has the advantageous effect of improving the aesthetic appearance of the exterior design and the optical performance of a display device when mounted on the display device, since the light blocking section of the display filter is formed on the periphery area of the base substrate in such a fashion that at least a portion of the periphery area becomes gradually darker in a predetermined direction.

In addition, the protective case has the advantageous effect of improving the aesthetic appearance of the exterior design and the optical performance of a display device when mounted on the display device, since it is formed in such a fashion that at least a portion of the bezel becomes gradually darker in a predetermined direction.

The methods and apparatuses of the present invention have other features and advantages which will be apparent from, or are set forth in more detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a cross-sectional view showing a PDP filter according to the invention;

FIG. 2 is a front view showing a PDP filter according to the invention;

FIGS. 3A and 3B are enlarged views showing a portion of the light-blocking section of a PDP filter according to the invention;

FIGS. 4A, 4B, and 4C are example diagrams explaining the gradation of the light-blocking section of the PDP filter;

FIGS. 5A and 5B are enlarged views showing a portion of a light-blocking section of a PDP filter according to the invention; and

FIG. 6 is a cross-sectional view taken along line A-A in FIG. 2.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

Herein, the term “gradation” refers to structure that expresses a change in lightness, for example, by arranging equal or different figures. The term “lightness” (or “value”) refers to the degree of being bright or dark.

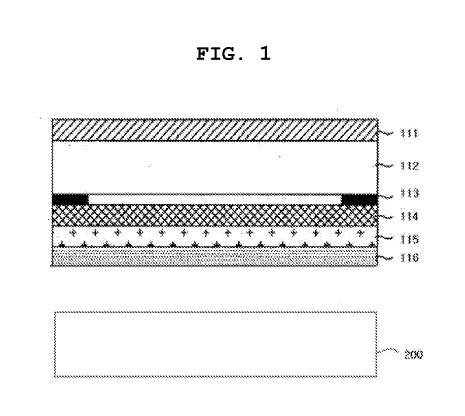

FIG. 1 is a cross-sectional view showing a PDP filter according to one exemplary embodiment of the invention.

As shown in FIG. 1, the display filter includes an antireflection film 111, a base substrate 112, a light blocking section 113, an EMI-shielding film 114, an NIR blocking film 115, and a color correction film 116. Here, the reference numeral 200 indicates a display module, which includes a drive circuit board, first and second substrates, and discharge cells.

The anti-reflection film 111 improves the contrast ratio of the PDP device by preventing the outward reflection of external light, which is incident from the viewer side. The anti-reflection film 111 can be a single layer film having an optical film thickness of, for example, ¼ of a wavelength of light. The single layer film can be formed as a thin film of transparent fluorine-based polymer resin, magnesium fluoride, silicon-based resin, silicon oxide, or the like, which has a low refractive index of 1.5 or less, and preferably 1.4 or less, in the visible wavelength range. The anti-reflection film 111 can have multi-layer structure that includes two or more layers of thin films having different refractive indices. The thin films can be made of an inorganic compound, such as metal oxide, fluoride, silicide, boride, carbide, nitride, sulfide, or the like, or an organic compound, such as silicon-based resin, acrylic resin, fluorine-based resin, or the like.

The base substrate 112 protects the display module 200. The base substrate 112 can be made of glass or transparent polymer. Examples of the transparent polymer may include Polyethylene Terephthalate (PET), acryl, Polycarbonate (PC), Urethane Acrylate (UA), polyester, epoxy acrylate, brominate acrylate, Polyvinyl Chloride (PVC), and the like.

The light blocking section 113 blocks display light emitted from the display module 200. The light blocking section 113 is formed on the periphery area of the base substrate 112 by using a light blocking material. For example, the light blocking section 113 can be formed on the base substrate 112 by forming a gradation on a silk screen having a mesh number ranging from 250 to 4500 per square inch, printing a light blocking material, for example, a black ceramic material on the base substrate, and curing by heat treatment. The light blocking section 113 is formed along the periphery of the base substrate 112 and determines the effective image-displaying area of the display module 200.

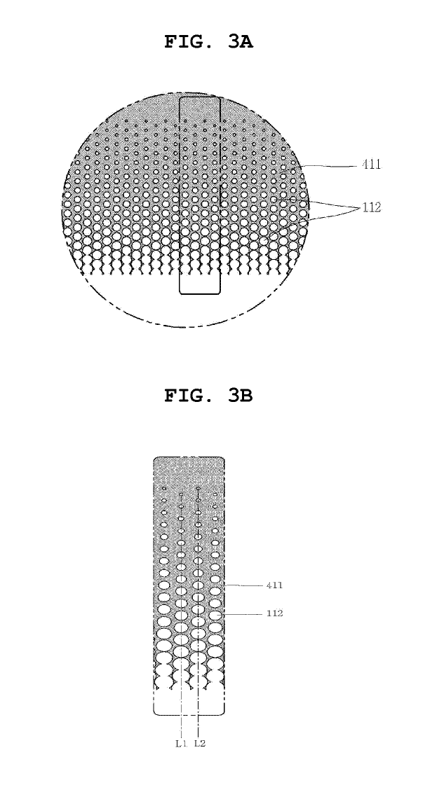

For example, the light blocking section is formed to be black along the periphery of the base substrate 112 in order to improve the visual sensation of the exterior of the PDP device and make the outline of the screen more prominent. It is preferred that the light blocking section be formed such that the lightness of the periphery area becomes gradually darker in a direction toward the effective image-displaying area of the display module 200. The structure of the light blocking section 113 will be described later with reference to FIGS. 3A to 5B.

The EMI shielding film 114 blocks EM radiation, which could otherwise have a harmful effect on the human body when emitted from the display module 200. The EMI shielding film can include a conductive mesh or can be formed as a multilayer transparent film in which a metal thin film and a high-refractivity transparent film are laminated. For example, the metal thin film can be made of Au, Ag, Cu, Pd, or the like, and the high-refractivity transparent film can be made of indium oxide, tin oxide, zinc oxide, or the like. The multilayer transparent film functions to block NIR radiation. Accordingly, when the multilayer transparent film is used as the EMI shielding film 114, the display filter can block both EM radiation and NIR radiation without using a separate NIR blocking film.

The NIR blocking film 115 serves to block NIR radiation, which would otherwise cause electronic devices, such as a mobile phone or a remote control, to malfunction. The NIR blocking film 115 contains an NIR-absorbing material, i.e., a material capable of absorbing NIR radiation. For example, the NIR-absorbing material can be selected from among mixed colorants in which Ni complex and di-imonium are mixed, compound colorants containing Cu ions and Zn ions, cyanine-based colorants, anthraquinone-based colorants, squarylium-based compounds, azomethine-based compounds, oxysonol compounds, azo-based compounds, benzylidene-based compounds, and the like.

The color correction film 116 increases the color reproduction range of the display device and improves the clarity of the display image. The color correction film 116 alters or corrects the color balance by reducing or adjusting the amounts of red (R), green (G), and blue (B) light. In addition, the color correction film can also contain a neon-cut colorant to absorb neon light to discolor red color of the light generated in the PDP device into orange color.

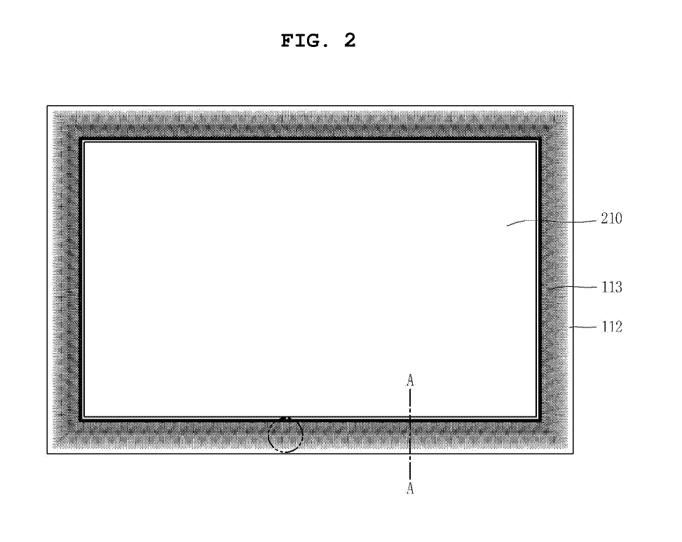

FIG. 2 is a front view showing a PDP filter according to one exemplary embodiment of the invention. As shown in FIG. 2, the effective image-displaying area has a prominent outline because of the light blocking section 113 formed on the periphery area of the base substrate 112.

Below, a description will be given of the structure of the light blocking section 113 with reference to FIGS. 3A to 5B.

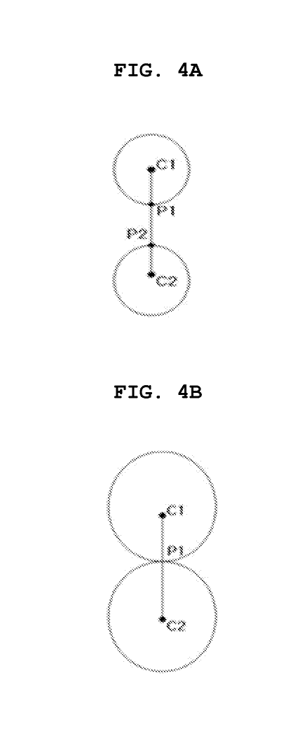

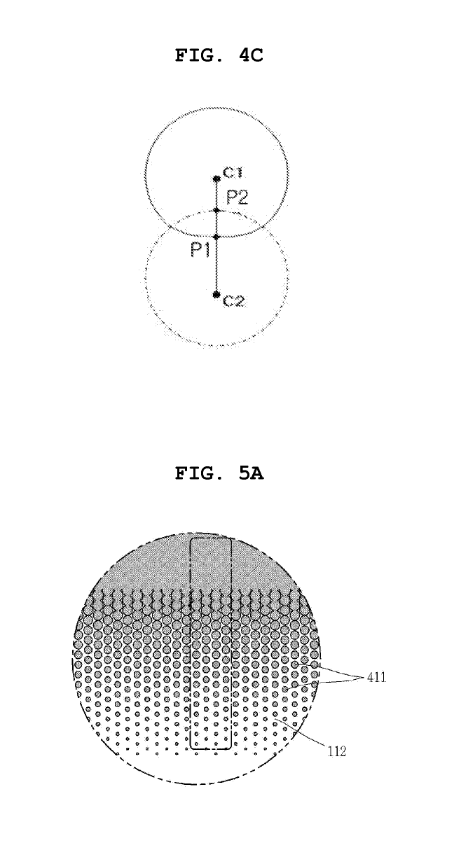

FIGS. 3A and 3B are enlarged views showing a portion of the light-blocking section 113 of a PDP filter, and FIGS. 4A, 4B, and 4C are example diagrams explaining the gradation of the light-blocking section 113 of the PDP filter.

First, with reference to FIGS. 3A and 3B, a light blocking material 411 on the periphery area of the base substrate 112 defines blank figures in the form of circles. Of course, the figures are not limited to circles but can also have polygonal shapes such as a triangle, quadrangle, or pentagon. The blank figures are arranged in, for example, a line that is perpendicular to the periphery of the base substrate 112 such that the center lines L1 and L2 connecting the centers of the blank figures are straight.

As shown in FIGS. 4A to 4C, the circular blank geometric structures formed on the base substrate 112 which are defined by the light blocking material can be divided generally into three blank figure groups.

As shown in FIG. 4A, in the first blank figure group, two adjacent blank figures are spaced apart from each other. That is, the distance between the centers C1 and C2 of two adjacent blank figures is greater than the sum of the distance between the center C1 and the point P1 and the distance between the center C2 and the point P2. Here, the points P1 and P2 are the points at which the line connecting the centers C1 and C2 meets the circumferences of the two blank figures.

As shown in FIG. 4B, in the second blank figure group, the distance between the centers C1 and C2 of two adjacent blank figures is the same as the sum of the distance between the center C1 and the point P1 and the distance between the center C2 and the point P1. Here, the point P1 is the point at which the line connecting the centers C1 and C2 meets the circumferences of the two blank figures.

As shown in FIG. 4C, in the third blank figure group, the distance between the centers C1 and C2 of two adjacent blank figures is smaller than the sum of the distance between the center C1 and the point P1 and the distance between the center C2 and the point P2. Here, the point P1 is the point at which the line connecting the centers C1 and C2 meets the circumferences of the two blank figures.

In an exemplary embodiment, the circular blank figure structure defined by the light blocking material 411 can be formed such that the distance between the adjacent center lines L1 and L2 is the same as the distance between the centers C1 and C2 of the two adjacent blank figures. In another exemplary embodiment, the distances between the centers C1 and C2 of the two adjacent blank figures in the first to third figure groups may be equal to one another.

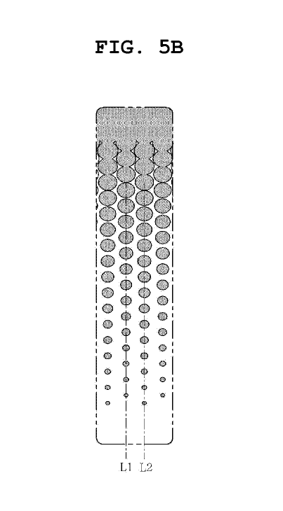

FIGS. 5A and 5B are enlarged views showing a portion of the light-blocking section 113 of a PDP filter according to another exemplary embodiment of the invention.

The light blocking section 113 of this embodiment is formed such that the light blocking material 411 on the periphery area of the base substrate 112 has a circular figure structure. Of course, the present invention is not limited to circles, but can have a polygonal figure structure such as that of a triangle, rectangle, or pentagon. For example, a plurality of figures of the light blocking material 411 is arranged in line in the direction perpendicular to the periphery, and the center lines L1 and L2 connecting the centers of figures are formed as straight lines.

As shown in FIGS. 5A and 5B, the light blocking section 113 has a light blocking material 411 inside circles which were blank in FIGS. 4A to 4C. The circular figure structure can be formed generally as three types of figure groups.

The first figure group includes figures, in which the distance between the centers C1 and C2 of two adjacent figures is greater than the sum of the distance between the center C1 and the point P1 and the distance between the center C2 and the point P2. Here, the points P1 and P2 are the points at which the line connecting the centers C1 and C2 meets the circumference of the two figures.

The second figure group includes figures, in which the distance between the centers C1 and C2 of two adjacent figures is the same as the sum of the distance between the center C1 and the point P1 and the distance between the center C2 and the point P1. Here, the point P1 is the point at which the line connecting the centers C1 and C2 meets the circumference of the two figures.

The third figure group includes figures, in which the distance between the centers C1 and C2 of two adjacent figures is smaller than the sum of the distance between the center C1 and the point P1 and the distance between the center C2 and the point P2. Here, the point P1 is the point at which the line connecting the centers C1 and C2 meets the circumference of the two figures.

In an exemplary embodiment, the circular figure structure of the light blocking material 411 can be formed such that the distance between the adjacent center lines L1 and L2 is the same as the distance between the centers C1 and C2 of the two adjacent figures. In another exemplary embodiment, the distances between the centers C1 and C2 of the two adjacent figures in the first to third figure groups may be equal to one another.

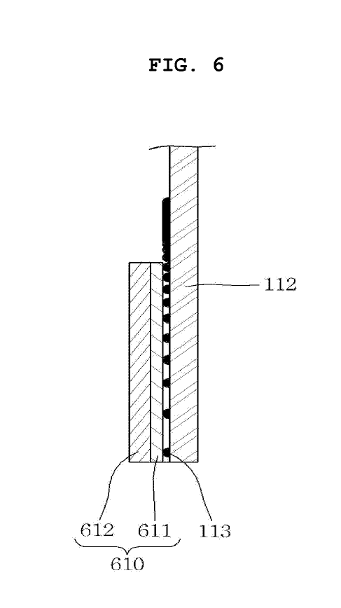

FIG. 6 is a cross-sectional view taken along line A-A in FIG. 2.

As shown in FIG. 6, the display filter having a gradation has the light blocking section 113 on the base substrate 112, and according to one aspect of the invention, can further include a color-adjusting film 610.

The color-adjusting film 610 is provided on a non-effective image-displaying area of the base substrate 112, i.e., a predetermined area that does not cover the effective image-displaying area. The color-adjusting film 610 contains a colorant to impart an additional visual sensation to a viewer. The color-adjusting film 610 can be formed on a predetermined portion of the light blocking section 113, for example, where the distance between the centers C1 and C2 of two adjacent blank figures is smaller than the sum of the distance between the center C1 and the point P1 and the distance between the center C2 and the point P1 as in FIG. 4C.

In an exemplary embodiment, the color-adjusting film 610 can include a transparent substrate 612 and a Pressure Sensitive Adhesive (PSA) layer 611 adhered to the transparent substrate 612. The PSA layer 611 may contain one or more selected from among a color-compensation colorant, a neon-cut colorant, an NIR blocking colorant, and a photoluminescent material. For example, the transparent substrate 612 can be a transparent polymer film such as a PET film or a TAC film.

Here, the photoluminescent material is a material that absorbs light and then re-radiates light. In detail, when the photoluminescent material absorbs light, its electrons are excited. Even when the light is not provided any more, the excited electrons do not drop directly to the bottom state but transit to a metastable state. Subsequently, the electrons emit light while returning to the bottom state from the metastable state. The photoluminescent material is generally divided into a green photoluminescent material, a blue photoluminescent material, and a red photoluminescent material. The photoluminescent material can be produced by mixing nano-powders of glass, polymer resin, PET, or the like. The photoluminescent material can continue to emit light for a short or long time in the dark, and the light emission time can be adjusted according to the composition of the photoluminescent material.

In another exemplary embodiment, the color-adjusting film 610 can also include a transparent substrate 612, a color-adjusting layer (not shown), which contains one or more selected from among a color-compensation colorant, a neon-cut colorant, an NIR blocking colorant, and a photoluminescent material, and a PSA layer 611 adhered to the color-adjusting layer. The color-adjusting film 610 containing the photoluminescent material can produce a fresh mood by emitting a delicate color in the dark.

In another exemplary embodiment, it is possible to provide only the color-adjusting layer without the backing of the transparent substrate or the adhesion of the adhesive layer.

Although it has been described herein that the color-adjusting film 610 is formed directly on the light blocking section 113, the present invention is not limited thereto. Alternatively, the color-adjusting film can be formed directly on the antireflection film 111 (see FIG. 1), the base substrate 112 (see FIG. 1), the EMI shielding film 114 (see FIG. 1), the NIR blocking film 115 (see FIG. 1), the color correction film 116 (see FIG. 1), or the like.

In addition, although it has been described that the light blocking material is applied on only the base substrate of the display filter, the present invention is not limited thereto. Rather, the light blocking material can be applied on the protective case used in a flat display device, or on the antireflection film 111 (see FIG. 1), the EMI shielding film 114 (see FIG. 1), the NIR blocking film 115 (see FIG. 1), or the color correction film 116 (see FIG. 1). For example, in the protective case, the light blocking section can be formed such that the light blocking material on the bezel, which forms the periphery of the front side, defines the effective image-displaying area of the display filter. The lightness of at least a portion of the bezel can become gradually decreased in a predetermined direction. The structure of the light blocking section formed on the protective case can be configured as described above with reference to FIGS. 3A to 5B.

In addition, although only the PDP device has been used to illustrate a display device to which the display filter having a gradation according to the exemplary embodiments of the invention is applied, the display filter having a gradation can also be applied to a Liquid Crystal Display (LCD), an Organic Electro Luminescent Display (OELD), a Digital Information Display (DID), or the like.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A display filter having a gradation, in use for a display device having a display module therein, the display filter comprising:
a base substrate; and
a light blocking section having a light blocking material formed on a periphery area of the base substrate to define an effective image-displaying area of the base substrate, wherein at least a portion of the light blocking section becomes gradually darker in a predetermined direction.

2. The display filter according to claim 1, wherein the at least a portion of the light blocking section becomes gradually darker in a direction toward the effective image-displaying area.

3. The display filter according to claim 1, wherein the light blocking section becomes gradually darker in a direction away from the effective image-displaying area.

4. The display filter according to claim 1, wherein the light blocking material forms a plurality of circular or polygonal figures, the figures including first to third figure groups arranged in a direction toward or away from the effective image-displaying area, wherein:
the distance between the centers of two adjacent figures in the first figure group is greater than the sum of the distance between the center of one of the two adjacent figures in the first figure group and the intersection point where the line connecting the centers of the two adjacent figures in the first figure group meets the circumference of the one of the two adjacent figures in the first figure group and the distance between the center of the other of the two adjacent figures in the first figure group and the intersection point where the line connecting the centers of the two adjacent figures in the first figure group meets the circumference of the other of the two adjacent figures in the first figure group,
the distance between the centers of two adjacent figures in the second figure group is equal to the sum of the distance between the center of one of the two adjacent figures in the second figure group and the intersection point where the line connecting the centers of the two adjacent figures in the second figure group meets the circumference of the one of the two adjacent figures in the second figure group and the distance between the center of the other of the two adjacent figures in the second figure group and the intersection point where the line connecting the centers of the two adjacent figures in the second figure group meets the circumference of the other of the two adjacent figures in the second figure group, and
the distance between the centers of two adjacent figures in the third figure group is smaller than the sum of the distance between the center of one of the two adjacent figures in the third figure group and the intersection point where the line connecting the centers of the two adjacent figures in the third figure group meets the circumference of the one of the two adjacent figures in the third figure group and the distance between the center of the other of the two adjacent figures in the third figure group and the intersection point where the line connecting the centers of the two adjacent figures in the third figure group meets the circumference of the other of the two adjacent figures in the third figure group.

5. The display filter according to claim 4, wherein the distances between the centers of the two adjacent figures in the first to third figure groups are equal to one another.

6. The display filter according to claim 1, wherein the light blocking material forms a plurality of circular or polygonal blank figures, the blank figures including first to third blank figure groups arranged in a direction toward or away from the effective image-displaying area, wherein:
the distance between the centers of two adjacent blank figures in the first blank figure group is greater than the sum of the distance between the center of one of the two adjacent blank figures in the first blank figure group and the intersection point where the line connecting the centers of the two adjacent blank figures in the first blank figure group meets the circumference of the one of the two adjacent blank figures in the first blank figure group and the distance between the center of the other of the two adjacent blank figures in the first blank figure group and the intersection point where the line connecting the centers of the two adjacent blank figures in the first blank figure group meets the circumference of the other of the two adjacent blank figures in the first blank figure group,
the distance between the centers of two adjacent blank figures in the second blank figure group is equal to the sum of the distance between the center of one of the two adjacent blank figures in the second blank figure group and the intersection point where the line connecting the centers of the two adjacent blank figures in the second blank figure group meets the circumference of the one of the two adjacent blank figures in the second blank figure group and the distance between the center of the other of the two adjacent blank figures in the second blank figure group and the intersection point where the line connecting the centers of the two adjacent blank figures in the second blank figure group meets the circumference of the other of the two adjacent blank figures in the second blank figure group, and
the distance between the centers of two adjacent blank figures in the third blank figure group is smaller than the sum of the distance between the center of one of the two adjacent blank figures in the third blank figure group and the intersection point where the line connecting the centers of the two adjacent blank figures in the third blank figure group meets the circumference of the one of the two adjacent blank figures in the third blank figure group and the distance between the center of the other of the two adjacent blank figures in the third blank figure group and the intersection point where the line connecting the centers of the two adjacent blank figures in the third blank figure group meets the circumference of the other of the two adjacent blank figures in the third blank figure group.

7. The display filter according to claim 6, wherein the distances between the centers of the two adjacent blank figures in the first to third figure groups are equal to one another.

8. The display filter according to claim 1, wherein the light blocking material comprises a black ceramic material.

9. The display filter according to claim 1, further comprising a color-adjusting layer in the periphery area, wherein the color-adjusting layer contains at least one selected from the group consisting of a color-compensation colorant, a neon-cut colorant, a near infrared blocking colorant, and a photoluminescent material.

10. The display filter according to claim 9, further comprising a transparent substrate on which the color-adjusting layer is formed such that the transparent substrate and the color-adjusting layer form a color-adjusting film.

11. The display filter according to claim 10, wherein the color-adjusting layer is a pressure sensitive adhesive layer adhered to the transparent substrate, wherein the pressure sensitive adhesive layer contains at least one selected from the group consisting of a color-compensation colorant, a neon-cut colorant, a near infrared blocking colorant, and a photoluminescent material.

12. The display filter according to claim 1, wherein the base substrate is made of glass or transparent polymer.

13. A protective case, in use for a display device having therein a display module and a display filter, the protective case comprising:
a bezel forming a periphery of a front side of the display device; and
a light blocking section having a light blocking material formed on the bezel to define an effective image-displaying area of the display filter, wherein at least a portion of the light blocking section becomes gradually darker in a predetermined direction.

14. The protective case according to claim 13, wherein the at least a portion of the light blocking section becomes gradually darker in a direction toward the effective image-displaying area.
